(19) United States
(12) Patent Application Publication
(10) Pub. No.: US 2011/0052799 A1
(43) Pub. Date: Mar. 3, 2011

(54) METHOD OF RECYCLING SCRAP MAGNET

(76) Inventors: Hiroshi Nagata, Ibaraki (JP); Yoshinori Shingaki, Ibaraki (JP)

(21) Appl. No.: 12/863,338

(22) PCT Filed: Feb. 18, 2009
(86) PCT No.: PCT/JP2009/052748

§ 371 Date: Aug. 26, 2010

(30) Foreign Application Priority Data
Feb. 20, 2008 (JP) 2008-039299

(51) Int. Cl. B05D 5/00

(52) U.S. Cl. 427/127

(57) ABSTRACT

The method has the steps of: grinding a recovered scrap magnet which is an iron-boron-rare earth-based sintered magnet, thereby obtaining a scrap-derived recovered raw material powder; obtaining a sintered body from the scrap-derived recovered raw material powder by a powder metallurgy method; and processing the sintered body. The processing includes the steps of: heating the sintered body disposed in a processing chamber; evaporating a metal evaporating material containing at least one of Dy and Tb in which the metal evaporating material is disposed in the same or another processing chamber; adhering metal atoms evaporated in the evaporating step to a surface of the sintered body while controlling a supply amount of the evaporated metal atoms; and diffusing the adhered metal atoms into grain boundaries and/or grain boundary phases of the sintered body.

This application is a national phase entry under 35 U.S.C. §371 of PCT Patent Application No. PCT/JP2009/052748, filed on Feb. 18, 2009, which claims priority under 35 U.S.C. §119 to Japanese Patent Application No. 2008-039299, filed Feb. 20, 2008, both of which are incorporated by reference.

### METHOD OF RECYCLING SCRAP MAGNET

1. Technical Field

The present invention relates to a method of recycling scrap magnets and relates, in particular, to a method of recycling scrap magnets in which: sintered magnets that have been once used or have been rejected in the course of a manufacturing step are recovered; and, without extraction by dissolution of specific elements out of the sintered magnets, the scrap magnets can be recycled into high-performance sintered magnets (permanent magnets).

2. Background Art

Nd—Fe—B-based sintered magnets (so-called neodymium magnets) can be manufactured at a low cost because they are made from a combination of iron and elements of Nd and B that are inexpensive and abundant as natural resources to enable a stable supply. In addition, they have high magnetic properties (maximum energy product is about 10 times that of a ferritic magnet). Therefore, they are used in a variety of products such as electronic devices, and are employed as electric motors and generators for hybrid vehicles, with the amount of their uses on the increase.

This kind of sintered magnets are mainly manufactured by a powder metallurgy process. In this method, Nd, Fe and B are first compounded at a predetermined ratio. At this time, in order to enhance the magnetic coercive force, scarce rare earth elements such as dysprosium and the like are mixed. An alloy raw material is then manufactured by melting and casting. The alloy raw material is once coarsely ground, e.g., in a hydrogen grinding process and is subsequently finely ground in, e.g., a jet mill fine grinding process (grinding step), thereby obtaining an alloy raw material powder. Subsequently, the obtained alloy raw material powder is oriented in a magnetic field (magnetic field orientation) and is compression-molded in a state of being charged with the magnetic field, thereby obtaining molded bodies. Finally, the molded bodies are sintered under predetermined conditions to thereby obtain sintered magnets (see patent document 1).

In the course of this kind of steps for manufacturing sintered magnets, scraps will be generated due to poor forming (poor molding), poor sintering and the like. Since the scraps contain therein scarce rare earth elements, they must be recycled from the viewpoint of preventing the resources from getting exhausted.

On the other hand, the sintered magnets have a Curie temperature of as low as about 300° C. as described above, and have a problem in that, depending on the conditions of the products in which the sintered magnets are employed, the sintered magnets will be demagnetized due to the heat. The sintered magnets that have been demagnetized cannot be reused for other purposes as they are. In this kind of cases, too, the above-mentioned sintered magnets will have to be scrapped. Therefore, it must be so arranged that this kind of scrapped products are also recyclable.

It is to be noted here that the scrapped magnets ordinarily contain impurities such as oxygen, nitrogen, carbon and the like due to oxidation, and the like at the time of sintering, and the average grain size has grown large due to grain growth at the time of sintering. Therefore, there is a problem in that magnets having a high coercive force cannot be obtained if the scrapped magnets are ground as they are for further recycling by a powder metallurgy method.

As a solution, it is conventionally known: after performing acid solution, to separate and refine rare earth elements such as neodymium, dysprosium and the like by a solvent extraction method; to separate them as sediments by adding hydrofluoric acid, oxalic acid, sodium carbonate and the like; to recover them and make them as oxides or fluorides; and to thereafter recycle them in fused-salt electrolysis and the like.

In addition, as a method of recycling scraps and sludge, the following is known in patent document 2. That is, the scraps are fed to a fused-salt electrolysis bath which contains rare earth oxides as the raw material; the scraps are separated in the electrolysis bath by solution into rare earth oxides and magnetic alloy parts; the rare earth oxides dissolved into the electrolysis bath are reduced into rare earth metals by electrolysis; and further, the magnetic alloy parts are alloyed with the rare earth metals that are generated by electrolytic reduction, thereby recycling the scraps as the rare earth metals-transition metals-boron alloy.

However, since in any one of the above-mentioned conventional examples the scrap magnets are recycled by undergoing a plurality of processing steps such as solvent extraction and the like as described above, there is a problem in that the productivity is poor and further that, since several kinds of solvents such as hydrofluoric acid and the like are used, a higher cost is incurred.

### Patent Document 1: JP-A-2004-6761

### Patent Document 2: JP-A-2004-296973

### DISCLOSURE OF THE INVENTION

### Problems to be Solved by the Invention

In view of the above points, this invention has a problem of providing an inexpensive method of recycling a scrap magnet, the method being capable of attaining a high productivity.

### Means of Solving the Problems

In order to solve the above-mentioned problems, the method of recycling a scrap magnet according to this invention comprises the steps of; grinding a recovered scrap magnet which is an iron-boron-rare earth-based sintered magnet, thereby obtaining a scrap-derived recovered raw material powder; obtaining a sintered body from the scrap-derived recovered raw material powder by a powder metallurgy method; and processing the sintered body. The processing includes the steps of; heating the sintered body disposed in a processing chamber; evaporating a metal evaporating material containing at least one of Dy and Tb, the metal evaporating material being disposed in the same or another processing chamber; adhering metal atoms evaporated in the evaporating step to a surface of a sintered body while controlling a supply amount of the evaporated metal atoms; and diffusing the adhered metal atoms into a grain boundary and/or a grain boundary phase of the sintered body.

According to this invention, after grinding the scrap magnet as it is to thereby obtain the scrap-derived recovered raw material powder, a sintered body is obtained by a powder metallurgy method. At this time, the sintered body contains many impurities such as oxygen and the like as compared with the sintered magnet prior to recycling, and the sintered body as it is cannot be made into a high-performance magnet having a high coercive force. As a solution, the following processing is performed, i.e., the sintered body is disposed in the processing chamber and heated, and also a metal evaporating material containing at least one of Dy and Tb is disposed in the same or in another processing chamber for causing it to be evaporated. The metal atoms are caused to get adhered to the surface of the sintered body by adjusting the supply amount of the evaporated metal atoms to the surface of the sintered body, and the adhered metal atoms are diffused into the grain boundary and/or the grain boundary phase of the sintered body (vacuum vapor processing).

According to this arrangement, as a result of diffusion and uniform distribution of Dy and/or Tb into the grain boundary and/or grain boundary phase of the sintered body, there can be obtained a high-performance recycled magnet which has a Dy-rich and/or Tb-rich phase (phase containing Dy and/or Tb in a range of 5 to 80%) in the grain boundary and/or grain boundary phase, in which Dy and/or Tb is diffused only near the surface of the grain boundary, and in which magnetizing force and coercive force have effectively been recovered.

As described above, according to this invention, after having recovered the scrap magnet, it is immediately returned to the grinding step and, after having obtained once again a sintered body by a metallurgy method, the sintered body is only subjected to the processing of the above-mentioned vacuum evaporating process. Therefore, a plurality of processing steps such as solvent extraction and the like are not required, thereby improving the productivity in obtaining a high-performance magnet. In addition, as a result of combined effect of being capable of reducing the production equipment, the cost can be reduced. At this time, since the scarce rare earth elements held in mixture in the scrap magnet before recycling can be reused as they are, this method is effective also from the viewpoint of preventing the natural resources from getting depleted.

In this invention, if a raw material powder obtained by grinding the alloy raw material for the iron-boron-rare earth-based sintered magnet manufactured by a quenching method is added to the scrap-derived recovered raw material powder, the amount of impurities such as oxygen and the like that are brought into the sintered body at the time of recycling can be minimized and, as a result, this recycled magnet can further be used for another recycling.

The grinding may be performed by each of the steps of hydrogen grinding and jet mill fine grinding.

This invention preferably further comprises the step of introducing an inert gas into the processing chamber in which the sintered body is disposed. The introduction is made while the metal evaporating material is being evaporated, so that the supply amount of the evaporated metal atoms is adjusted by varying a partial pressure of the inert gas, and that the metal atoms are diffused into the grain boundary and/or the grain boundary phase before a thin film made from the adhered metal atoms is formed. According to this arrangement, the surface conditions of the permanent magnet after the processing are substantially the same as those before the processing. The finish-machining of the surface is not required and the productivity can further be enhanced.

Preferably, this invention further comprises the step of performing a heat treatment at a temperature below the heating temperature, after having diffused the metal atoms into the grain boundary and/or the grain boundary phase of the sintered body. Then, the magnetic properties of the recycled sintered magnet can advantageously be improved.

### BEST MODE FOR CARRYING OUT THE INVENTION

With reference to the accompanying drawings, a description will now be made of a method of recycling scrap magnets which are iron-boron-rare earth-based sintered magnets according to an embodiment of this invention.

As the scrap magnets, there are scraps which occur due to poor forming, poor sintering and the like in the course of steps of manufacturing sintered magnets, and there are also used second-hand product scraps. Here, in the case of the product scraps, there are cases where protection films are formed by Ni plating and the like to impart, e.g., corrosion resistance. In such a case, in the same manner as in the prior art, the protection film is peeled off by a known peeling method prior to recycling depending on the kind of the protection film, and is washed when appropriate.

The recovered scrap magnets (scrap-derived recovered magnets) are appropriately crushed or ground into thin pieces of about 5 to 10 mm thick by using, e.g., a stamping mill depending on their shape and size, and are further coarse-ground in a known hydrogen grinding step. In this case, depending on the shape and size of the scrap magnets, they may be coarse-ground in the hydrogen grinding step without grinding them into thin pieces. Subsequently, they are fine-ground in the nitrogen gas atmosphere in a jet mill fine grinding step into a recovered raw material powder (scrap-derived recovered raw material powder) having an average particle size of 3 to 10 μm.

It is to be noted here that the above-mentioned scrap magnets contain many impurities such as oxygen, nitrogen, carbon and the like due to oxidation, e.g., at the time of sintering. In this kind of case, if for example the oxygen and carbon content exceed a predetermined value (e.g., about 8000 ppm in case of oxygen, 1000 ppm in case of carbon), there will be a disadvantage in that, e.g., the liquid phase sintering cannot be attained in the sintering step.

Therefore, in the embodiment of this invention, an arrangement was made, depending on the content of impurities in the scrap sintered magnets, such that a Nd—Fe—B-based raw material powder was mixed in a predetermined mixing ratio. In this case, in order to obtain a high-performance sintered magnet while accelerating the speed of diffusion of the metal atoms into the sintered body (sintered magnet) at the time of vacuum vapor processing which is described hereinafter, the mixing amount of the raw material powder shall preferably be set such that the oxygen content in the sintered magnet itself falls below 3000 ppm.

The raw material powder is manufactured in the following manner. In other words, in order for Fe, Nd and B to attain a predetermined composition ratio, industrial pure iron, metal neodymium and low-carbon ferroboron are mixed and melted by using a vacuum induction furnace, and by a quenching method, e.g., by a strip casting method, an alloy raw material of 0.05 to 0.5 mm is prepared first. Otherwise, an alloy raw material of about 5 to 10 mm thick may be first prepared by a centrifugal casting method. At the time of mixing, addition may be made of Dy, Tb, Co, Cu, Nb, Zr, Al, Ga ad the like. It is preferable to make the total content of the rare earth elements larger than 28.5% so as to obtain an ingot in which alpha iron is not generated.

Then, the prepared alloy raw material is coarsely ground by a known hydrogen grinding step and is subsequently finely ground by a jet mill fine grinding step in a nitrogen atmosphere. As a result, a raw material powder of average particle size of 3 to 10 μm can be obtained. As to the timing of mixing the raw material powder and the scrap-derived recovered raw material powder, there is no particular requirement. However, if both powders are mixed before they are subjected to hydrogen grinding step, or at the time when one of the two powders is finely ground, the other of the two powders may be mixed together so that the two powders are ground while getting mixed together. Then, the grinding step can advantageously be made efficient.

Then, the scrap-derived recovered raw material powder or a mixed fine powder of the scrap-derived recovered raw material powder and the raw material powder is compression molded into a predetermined shape in the magnetic field by using a known compression molding machine. Then, the molded body taken out of the compression molding machine is housed inside a sintering furnace (not illustrated), and is subjected to a liquid phase sintering (sintering step) at a predetermined temperature (e.g., 1050° C.) in vacuum for a predetermined period of time, thereby obtaining a sintered body (powder metallurgy method). Thereafter, by means of machining using a wire cutter and the like, the obtained sintered body is appropriately worked into a predetermined shape. Then, the sintered body (sintered magnet) S thus obtained is subjected to vacuum vapor processing. A description will now be made, with reference to FIG. 1, of a vacuum vapor processing apparatus which performs the vacuum vapor processing.

A vacuum vapor processing apparatus 1 has a vacuum chamber 3 which can be evacuated to a predetermined pressure (e.g., 1×10⁻⁵ Pa) and is maintained thereat through an evacuating means such as a turbo molecular pump, cryo pump, diffusion pump and the like. The vacuum chamber 3 is provided inside thereof with a heating means 4 constituted by an insulating material (heat insulating material) 41 which encloses the circumference of a processing box (to be described hereinafter), and a heat generating means 42 which is disposed on the inside of the insulating material. The insulating material 41 is made, e.g., of Mo, and the heat generating means 42 is a heater having a filament (not illustrated) of Mo make. By applying power from a power source (not illustrated) to the filament, the space 5 which is enclosed by the insulating material 41 and in which a processing box is disposed can be heated by an electrical resistance heating system. In this space 5 there is disposed a placing table 6, e.g., of Mo make. It is thus so arranged that at least one processing box 7 can be placed in position on the placing table.

The processing box 7 is constituted by a rectangular parallelepiped box portion 71 which is open on an upper surface, and a lid portion 72 which is detachably mounted on the upper surface of the box portion 71 which is left open. Along an entire peripheral edge of the lid portion 72, there is formed a flange 72a which is bent downward. When the lid portion 72 is mounted in position on the upper surface of the box portion 71, the flange 72a gets engaged with an outer wall of the box portion 71 (in this case, there is provided no vacuum sealing such as a metallic seal). As a result, there is defined a processing chamber 70 which is isolated from the vacuum chamber 3. Then, when the vacuum chamber 3 is evacuated down to a predetermined pressure (e.g., 1×10⁻⁵ Pa) by operating the evacuating means 2, the processing chamber 70 will be reduced in pressure to a substantially half-digit higher pressure (e.g., 5×10⁻⁴ Pa) than the pressure in the vacuum chamber 3. According to this arrangement, the processing chamber 70 can be reduced to a predetermined vacuum pressure without the need for an additional evacuating means.

As shown in FIG. 1, in the box portion 71 of the processing box 7, there are housed therein the above-mentioned sintered magnets S and metal-evaporating materials v in a vertically stacked manner respectively with a spacer 8 interposed therebetween to prevent them from getting into contact with each other. Each of the spacers 8 is constituted into a lattice shape by assembling a plurality of wire materials 81 (e.g., Φ0.1 to 10 mm) in a manner to become smaller in area than the cross-sectional surface of the box portion 71, and each of the peripheral edge portions is bent upward substantially at right angles (see FIG. 2). The height of the bent portions is set to be higher than the height of the sintered bodies S to be subjected to vacuum vapor processing. A plurality of sintered bodies S are disposed on the horizontal portions of the spacers 8 at an equal spacing from one another. The spacers 8 may alternatively be constituted by a so-called expanded metal.

As the metal evaporating materials v, there are used Dy and Tb which largely improve the crystal magnetic anisotropy of the main phase, or an alloy which is prepared by mixing metals which further enhance the coercive force such as Nd, Pr, Al, Cu, Ga and the like into Dy and Tb (mass ratio of Dy or Tb is above 50%). After mixing each of the above-mentioned metals in a predetermined mixing ratio, the mixture is melted in, e.g., an electric arc furnace, and is then formed into a plate shape of a predetermined thickness. In this case, the metal evaporating materials v have each an area so as to be supported by an entire upper circumference of the peripheral edge portion, which is bent upward substantially at right angles, of the respective spacers 8.

After disposing a plate-shaped metal evaporating material v on the bottom surface of the box portion 71, there are placed on the upper side thereof a spacer 8 on which the sintered magnets S are placed in position and another plate-shaped metal evaporating material v. In this manner, the metal evaporating materials v and the spacers 8, each of the spacers having placed thereon a plurality of sintered magnets S, are alternately stacked with each other into vertical layers to the upper end portion of the processing box 7 (see FIG. 2). Above the uppermost spacer 8 the lid portion 72 is positioned close thereto and, therefore, the metal evaporating material v may be omitted.

The processing box 7 and the spacers 8 may also be manufactured in materials other than Mo, e.g., in W, V, Nb, Ta or an alloy thereof (inclusive of a rare earth-added type of Mo alloy, Ti-added type of Mo alloy, and the like), or in CaO, Y₂O₃, or may otherwise be manufactured in rare earth oxides, or else, may be constituted by forming a film of the above-mentioned material(s) as an inner lining on the surface of another insulating material. According to this arrangement, reaction products through reaction with Dy or Tb can advantageously be prevented from being formed on the surface thereof.

By the way, in case the metal evaporating materials v and the sintered bodies S are vertically stacked in a sandwiched structure inside the processing box 7 as described above, the space between the metal evaporating materials v and the sintered bodies S becomes small. If the metal evaporating materials v are evaporated in this kind of state, there is a possibility that the sintered bodies S will be largely effected by the rectilinear properties of the evaporated metal atoms. In other words, among the sintered bodies S, the metal atoms are likely to get adhered locally to those surfaces of the sintered bodies S which lie opposite to the metal evaporating materials v. In addition, Dy or Tb is likely to be hardly supplied to the portions that are shaded at the surfaces of contact of the sintered bodies S with the spacers 8. Therefore, when the above-mentioned vacuum vapor processing is carried out, the recycled magnets M thus obtained will have portions with locally higher coercive force and portions with locally lower coercive force. As a result, the squareness of the demagnetization curve will be impaired.

In the embodiment of this invention, the vacuum chamber 3 is provided with an inert gas introduction means. The inert gas introduction means has a gas introduction pipe 9 which is communicated with the space 5 enclosed by the insulating material 41. The gas introduction pipe 9 is communicated with a gas source for an inert gas through a massflow controller (not illustrated). In the course of the vacuum vapor processing, an inert gas such as He, Ar, Ne, Kr, N₂ and the like is introduced in a constant amount. It may alternatively be so arranged that the amount of the inert gas to be introduced is varied during the vacuum vapor processing (i.e., the introduction amount of the inert gas is made larger at the beginning and is subsequently made smaller, or else, the introduction amount of the inert gas is made smaller at the beginning and is subsequently made larger, or the above-mentioned operations are repeated). The inert gas is introduced, e.g., after the metal evaporation materials v have started evaporation or after they have reached a predetermined heating temperature. The inert gas may be introduced during the set time of the vacuum vapor processing or for a predetermined period of time before and after the vacuum vapor processing. It is preferable to provide an evacuating pipe communicated with the evacuating means 2, with a valve 10 which is adjustable in its opening degree so that, when the inert gas is introduced, the partial pressure of the inert gas inside the vacuum chamber 3 can be adjusted.

According to this arrangement, the inert gas that is introduced into the space 5 is also introduced into the processing box 7. At this time, since the mean free paths of the metal atoms of Dy or Tb are short, the metal atoms evaporated inside the processing box 7 will be diffused by the inert gas. The amount of metal atoms to be adhered directly to the surfaces of the sintered magnets S will therefore decrease, and also the metal atoms come to be supplied to the surfaces of the sintered magnets S from a plurality of directions. Therefore, even in case the spacing between the sintered bodies S and the metal evaporating materials V is small (e.g., 5 mm or less), the evaporated Dy or Tb will get adhered even to those portions which are shaded by the wire materials 81, as a result of wrapping around of the Dy or Tb to the shaded portions. Consequently, the maximum energy product and the remanent magnetic flux density can be prevented from getting lowered by an excessive diffusion of the metal atoms of Dy or Tb into the crystal grains. In addition, the presence of locally high coercive force and locally low coercive force can be reduced, thereby preventing the squareness of the demagnetization curve from getting impaired.

Next, a description will now be made of a vacuum vapor processing by using the above-mentioned vacuum vapor processing apparatus 1 and in which Dy is employed as the metal evaporating material v. As described hereinabove, the sintered bodies S and the metal evaporating materials v are alternately stacked through spacers 8 therebetween, and both are disposed in position first (as a result, the sintered bodies S and the metal evaporating materials v are arranged at a space therebetween inside the processing chamber 70). Then, after having mounted the lid portion 72 on the opened upper surface of the box portion 71, the processing box 7 is placed in position on the table 6 inside the space 5 enclosed by the heating means 4 in the vacuum chamber 3 (see FIG. 1). Then, through the evacuating means 2, the vacuum chamber 3 is reduced in pressure by evacuating until it reaches a predetermined pressure (e.g., 1×10⁻⁴ Pa) (the processing chamber 70 is evacuated to a pressure which is about half a digit higher than that of the processing chamber 70). When the vacuum chamber 3 has reached the predetermined pressure, the heating means 4 is operated to heat the processing chamber 70.

When the temperature in the processing chamber 70 has reached a predetermined temperature under reduced pressure, Dy in the processing chamber 70 will be heated to substantially the same temperature as that of the processing chamber 70 and starts evaporating, whereby a Dy vapor atmosphere will be formed inside the processing chamber 70. At this time, the gas introduction means is operated to thereby introduce an inert gas into the vacuum chamber 3 in a certain introduction amount. At the same time, the inert gas is introduced also into the processing chamber 7. The metal atoms evaporated inside the processing chamber 70 will be diffused by the inert gas.

Since the sintered magnets S and Dy are arranged not to come into contact with each other, even in case the Dy has started evaporation, the melted Dy will not get directly adhered to the sintered magnets S whose Nd-rich phase on the surface is melted. Then, the Dy atoms in the Dy vapor atmosphere as diffused inside the processing box are supplied from a plurality of directions either directly or by repeating collisions, and get adhered to the entire surfaces of the sintered magnets S that have been heated to substantially the same temperature as that of Dy. The adhered Dy will be diffused into the grain boundaries and/or grain boundary phases of the sintered magnets S.

Here, if the Dy atoms in the Dy vapor atmosphere are supplied to the surfaces of the sintered magnets S so that the Dy layer (thin film) can be formed, the surfaces of the permanent magnets M will be remarkably deteriorated (surface roughness becomes poor) when the Dy that has adhered to, and deposited on, the surfaces of the sintered magnets S gets re-crystallized. In addition, the Dy adhered to, and deposited on, the surfaces of the sintered magnets S that have been heated to substantially the same temperature will be resolved and excessively diffused into the grain boundary in the region near the surfaces of the sintered magnets S, whereby the magnetic properties cannot be effectively improved or recovered.

In other words, once the thin film of Dy has been formed on the surfaces of the sintered magnets S, the average composition of the surfaces of the sintered magnets S adjacent to the thin film becomes Dy-rich composition. Once the Dy-rich composition has been formed, the liquid phase temperature lowers and the surfaces of the sintered magnets S come to be melted (i.e., the main phase gets melted and the amount of liquid phase increases). As a result, the neighborhood of the surfaces of the sintered magnets S will be melted and get out of shape, resulting in an increase in projections and recessions. Moreover, Dy is excessively penetrated into the crystal grains together with a large amount of liquid phase. Consequently, the maximum energy product and remanent magnetic flux density exhibiting the magnetic properties will further be lowered.

In the embodiment of this invention, when the metal evaporating material v is Dy, in order to control the amount of evaporation of the Dy, the heating means 4 was controlled to set the temperature inside the processing chamber 70 to a range of 800 to 1050° C., preferably to a range of 850 to 950° C. (e.g., when the temperature inside the processing chamber is 900 to 1000° C., the saturated vapor pressure of Dy is about 1×10⁻² to 1×10⁻¹ Pa).

If the temperature in the processing chamber 70 (and consequently the temperature of heating the sintered magnets 5) is below 800° C., the speed of diffusion of the Dy atoms adhered to the surfaces of the sintered magnets S, into the grain boundaries and/or the grain boundary phases becomes lower. As a result, the Dy atoms cannot be uniformly diffused into the grain boundaries and/or the grain boundary phases before the thin film is formed on the surfaces of the sintered magnets S. On the other hand, at a temperature above 1050° C., the vapor pressure of Dy becomes high and, therefore, there is a possibility that the Dy atoms in the vapor atmosphere are excessively supplied to the surfaces of the sintered magnets S. In addition, there is a possibility that the Dy is diffused into the crystal grains. If the Dy is diffused into the crystal grains, the magnetization inside the crystal grains will largely be lowered and, therefore, the maximum energy product and the remanent magnetic flux density will further be lowered.

In addition, an arrangement was made such that the partial pressure of the inert gas introduced into the vacuum chamber 3 falls within a range of 3 to 50000 Pa by varying the opening degree of the valve 10. At a pressure below 3 Pa, Dy or Tb will get adhered locally to the sintered magnets S, resulting in impairing of the squareness of demagnetization curve. At a pressure above 50000 Pa, on the other hand, the evaporation of the metal evaporating materials v will be suppressed, thereby bringing about an excessively longer processing time.

According to the above arrangement, by controlling the amount of evaporation of Dy as a result of adjusting the partial pressure of the inert gas such as Ar and the like, and by diffusing the evaporated Dy atoms in the processing box as a result of introducing the inert gas, there can be attained the effects: of adhering the Dy atoms to the entire surfaces of the sintered magnets S while restricting the amount of supply of the Dy atoms to the sintered magnets S; and of accelerating the speed of diffusion by heating the sintered magnets S in the predetermined temperature range. Due to the above-mentioned combined effects, before the Dy atoms get deposited on the surfaces of the sintered magnets S to thereby form Dy layers (thin films), the Dy atoms adhered to the surfaces of the sintered magnets S can be efficiently diffused into, and uniformly penetrated into, the grain boundaries and/or grain boundary phases of the sintered magnets S (see FIG. 3). As a result, the surfaces of the recycled magnets M can be prevented from getting deteriorated. Also, the Dy can be prevented from getting excessively diffused into the grain boundaries in the regions near the surfaces of the sintered magnets, and the grain boundary phases have the Dy-rich phase (phase containing Dy in the range of 5 to 80%). Further, by diffusing Dy only near the surfaces of the crystal grains, the magnetizing force and the coercive force can be effectively recovered.

In addition, there are cases where, at the time of machining, cracks occur in the crystal grains which are the main phase on the surfaces of the sintered magnets, whereby the magnetic properties are remarkably deteriorated. However, by forming the Dy-rich phase on the inside of the cracks of the crystal grains near the surfaces (see FIG. 3), the magnetic properties can be prevented from getting impaired and, in addition, the sintered magnets have extremely strong corrosion resistance and weather resistance.

In addition, even in case where the metal atoms evaporated in the processing box 7 are present therein in a diffused state, and the sintered magnets S are placed in position on the spacers 8 made by assembling small wire materials 81 into a lattice shape, and the spacing between the sintered magnates S and the metal evaporating materials v is small, evaporated Dy or Tb gets wrapped around even to the portions which are shaded by the wire materials 81 and gets adhered thereto. As a result, the presence of portions where coercive force is locally high or locally low can be suppressed. Even if the above-mentioned vacuum vapor processing is carried out on the sintered magnets S, the squareness of the demagnetization curve is prevented from getting impaired.

Finally, once the processes as described above have been carried out for a predetermined period of time (e.g., 4 to 48 hours), the operation of the heating means 4 is stopped and the introduction of the inert gas by the gas introduction means is stopped once. Subsequently, the inert gas is introduced once again (100 kPa) and stop the evaporation of metal evaporating materials v. Alternatively, without stopping the introduction of the inert gas, only the amount of its introduction may be increased so as to stop the evaporation. Then, the temperature inside the processing chamber 70 is once lowered to, e.g., 500° C. Subsequently, the heating means 4 is operated once again. By setting the temperature inside the processing chamber 70 to a range of 450 to 650° C., heat treatment is carried out in order to further improve or recover the coercive force. Then, after being quenched to substantially the room temperature, the processing box 7 is taken out of the vacuum chamber 3.

As described, according to the embodiment of this invention, only the following are performed, i.e., the scrap magnets are recovered and are immediately ground and, after having obtained the sintered bodies S by a powder metallurgy method, they are subjected to the above-mentioned vacuum vapor processing. Therefore, as a result of combined effects in that a plurality of processing steps such as solvent extraction and the like are rendered needless, and that the finish machining becomes needless, the productivity in obtaining high-performance recycled magnets can be improved and, in addition, lower costs can be attained. At that time, since the scarce rare earth elements that were contained in the scrap magnets before recycling can be reused as they are, this invention is also effective from the viewpoint of preventing the natural resources from getting depleted. In addition, by controlling the oxygen content in the magnets below a predetermined value (e.g., 3000 ppm) by appropriately mixing the raw material powder, the recycled magnets manufactured as described above can be put to a further recycled use.

In this embodiment, a description was made of the spacer 8 which was constituted by assembling wire materials into a lattice shape and in which supporting pieces were integrally formed therewith. The spacer is, however, not limited thereto and any embodiment will do as long as it allows the evaporated metal atoms to pass therethrough. Further, a description was made of an example in which the metal evaporating material v was formed into a plate shape, but it is not limited thereto. On an upper surface of the sintered magnets that are disposed on a spacer member, another spacer formed by assembling wire materials into a lattice shape may be placed, and the spacer may be spread thereon with particulate metal evaporating materials.

Further, in this embodiment, a description was made of an example in which Dy was used as the metal evaporating material. Alternatively, there may be used Tb or a mixture of Dy and Tb which are low in vapor pressure within the heating temperature range of the sintered body S in which the diffusion speed of the sintered body S can be accelerated. Where Tb is used, the processing chamber 70 may be heated in the range of 900 to 1150° C. At a temperature below 900° C. there will not be reached the vapor pressure at which the Tb atoms can be supplied to the surfaces of the sintered magnets S. At a temperature above 1150° C., on the other hand, Tb will be diffused excessively into the crystal grains, thereby lowering the maximum energy product and the remnant magnetic flux density.

In addition, in order to remove the stains, gases and moisture adsorbed on the surfaces of the sintered bodies S before Dy or Tb is diffused into the grain boundaries and/or grain boundary phases, an arrangement may be made such that the vacuum chamber 3 is reduced in pressure through the evacuating means 2 down to a predetermined pressure (e.g., 1×10⁻⁵ Pa) and that the pressure is maintained for a predetermined period of time. At that time, the heating means 4 may be operated to heat the processing chamber 70 to, e.g., 100° C. and to maintain the temperature thereof for a predetermined period of time.

Further, in this embodiment, a description was made of an example in which, after having obtained the sintered bodies S, they are subjected to the vacuum vapor processing as they are. Alternatively, the following processing may be carried out, namely: the sintered bodies thus manufactured are housed into a vacuum heat treatment chamber (not illustrated); they are heated to a predetermined temperature in a vacuum atmosphere; and by taking advantage of a difference in vapor pressures at a certain temperature (e.g., at 1000° C., the vapor pressure of Nd is 10⁻³ Pa, the vapor pressure of Fe is 10⁻⁵ Pa, and the vapor pressure of B is 10⁻¹³ Pa), only the rare earth elements R in the R-rich phase of the primary sintered bodies are evaporated.

In this case, the heating temperature shall be set to a temperature above 900° C. and below the sintering temperature. At a temperature below 900° C., the evaporation speed of the rare earth elements R will be slow and, at a temperature exceeding the sintering temperature, an abnormal grain particle growth will take place, thereby largely lowering the magnetic properties. Further, the pressure inside the furnace shall be set to a pressure below 10⁻³ Pa because, at a pressure above 10⁻³ Pa, the rare earth elements R cannot be efficiently evaporated. According to the above-mentioned arrangement, the ratio of the Nd-rich phase consequently decreases and there can be manufactured high-performance recycled magnets S in which maximum energy product ((BH) max) and remnant magnetic flux density (Br) representing the magnetic properties are further improved.

### Example 1

In Example 1, scrap magnets used in hybrid cars were recovered to thereby manufacture recycled magnets. The scrap magnets were manufactured from raw materials of industrial pure iron, metal neodymium, low-carbon ferroboron, and metal cobalt mixed in a mixing composition (% by weight) of 23Nd-6Dy-1Co-0.1Cu-0.1B-Bal.Fe. Further, since the recovered scrap magnets were subjected to surface treatment such as Ni plating and the like, a known peeling agent was used to peel the surface treatment layer (protection film) and the scrap magnets were then washed. Thereafter, the scraps were crushed or ground to a size of about 5 mm, whereby the scrap-derived recovered raw materials were obtained. Further, with industrial pure iron, metal neodymium, and low-carbon ferroboron as main raw materials, mixing composition (% by weight) of 24 (Nd+Pr)-6Dy-1Co-0.1Cu-0.1Hf-0.1Ga-0.98B-Bal.Fe was subjected to vacuum induction melting, and thin plate-shaped ingots (melted materials) of about 0.4 mm thick were obtained by a strip casting method.

Then, the scrap-derived recovered materials were mixed with the above-mentioned raw material powder in a predetermined mixing ratio, and were once coarse-ground by a known hydrogen grinding step. In this case, the hydrogen grinding apparatus was operated at a batch of 100 kgs in hydrogen atmosphere of 1 atmospheric pressure for 5 hours. Thereafter, dehydration processing was carried out under conditions of temperature at 600° C. for 5 hours. Then, after cooling, the mixed powder was finely ground by a jet mill fine grinding apparatus. In this case, the fine grinding processing was carried out in nitrogen grinding gas of 8 atmospheric pressure, whereby a mixed raw material powder of average particle size of 3 μm was obtained.

Then, by using a transverse magnetic field compression molding apparatus whose construction is known in the art, there were obtained molded bodies of 50 mm×50 mm×50 mm in the magnetic field of 18 kOe. Subsequently, after having processed the molded bodies in vacuum degassing processing, they were subjected to liquid phase sintering in a vacuum sintering furnace at 1100° C. for 2 hours, thereby obtaining sintered bodies S. Then, by subjecting them to heat treatment for 2 hours at 550° C., there were obtained sintered bodies that were taken out after cooling. By wire cutting, the sintered magnets were machined to a shape of 40×20×7 mm, and then the surfaces thereof were washed with nitric acid-based etching solution.

Then, by using the vacuum vapor processing apparatus 1 as shown in FIG. 1, the sintered magnets S that were manufactured as described above were subjected to vacuum vapor processing. In this case, by using Dy (99.5%) formed into a plate shape of 0.5 mm thick as the metal evaporating materials v, and the metal evaporating materials v and the sintered magnets S were housed into the processing box 7 of Nb make. Then, after the pressure inside the vacuum chamber 3 has reached 10⁻⁴ Pa, the heating means 4 was operated, and the vapor processing was carried out by setting the temperature inside the processing chamber 70 to 850° C. and the processing time to 18 hours, whereby recycled magnets were obtained.

FIG. 4 is a table showing: average values of magnetic properties (measured by a BH curve tracer) and average oxygen content (measured in absorption spectrometry by using an infrared-absorbing analyzer made by LECO Corporation) at the time of manufacturing the recycled magnets while changing the mixing ratio of the raw material powder to the scrap-derived recovered raw material powder; and also average values of magnetic properties and the oxygen content of the sintered bodies S before vacuum vapor processing.

According to this table, in case the sintered bodies S were manufactured only from the scrap-derived recovered raw material powder, it can be seen that the coercive force was as low as 16.5 kOe, but that the coercive force improved to the level of 23.5 kOe when the sintered bodies were subjected to vacuum vapor processing. Further, it can be seen that the average values of the oxygen content increased by about only 20 ppm and that high-performance recycled magnets were obtained. Still furthermore, in case recycled magnets were manufactured by mixing molten raw material into the scrap-derived recovered raw material, it can be seen that the coercive force improved with an increase in the ratio of mixing the molten material, and also that the oxygen content can be reduced. As a result, it can be seen that the recycled magnets that were regenerated by applying this invention are also effective in further or repeated recycling.

### BRIEF DESCRIPTION OF THE DRAWINGS

FIG. 1 is a schematic sectional view of a vacuum vapor processing apparatus for performing vacuum vapor processing;

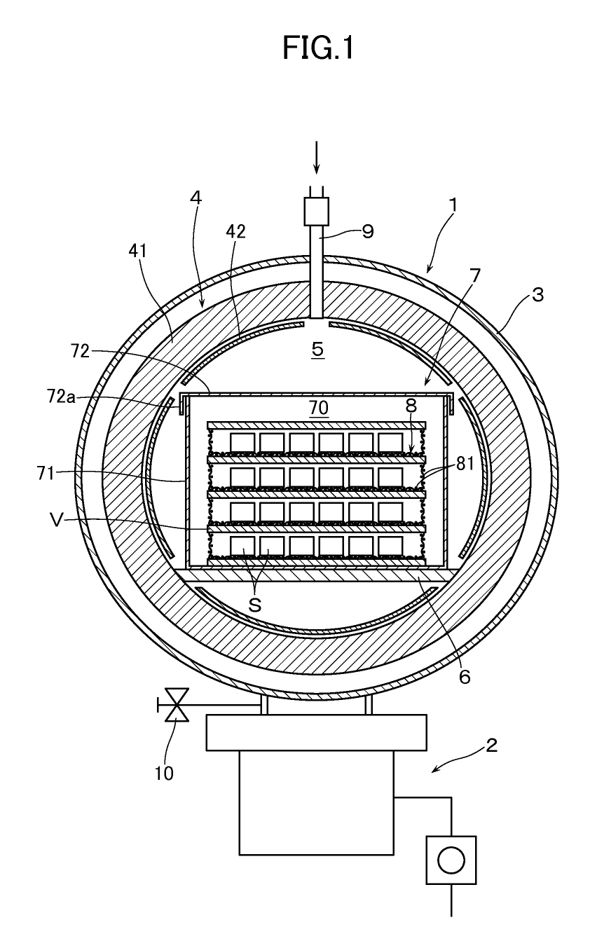

FIG. 2 is a perspective exploded view schematically explaining the loading of sintered magnets and metal evaporating materials into a processing box;

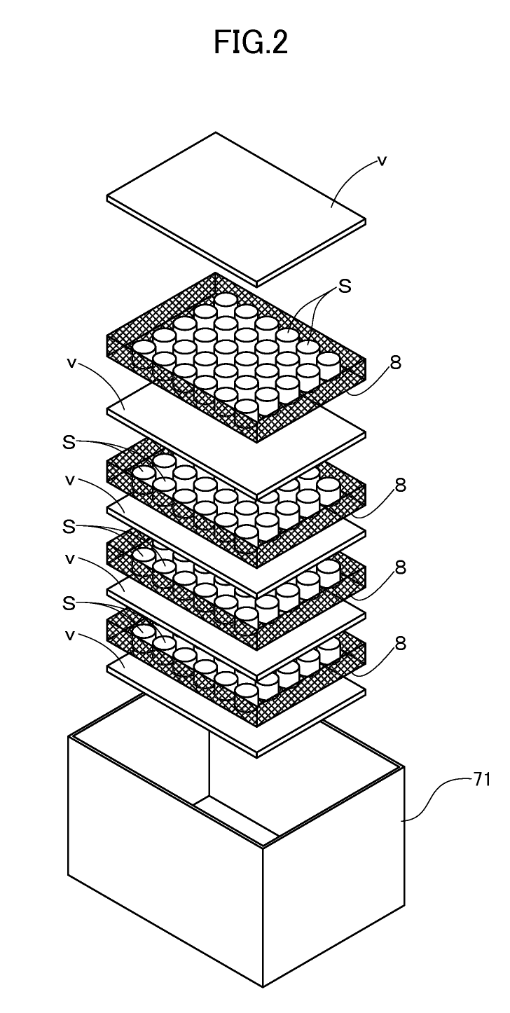

FIG. 3 is a sectional view schematically explaining section of a permanent magnet manufactured according to this invention; and

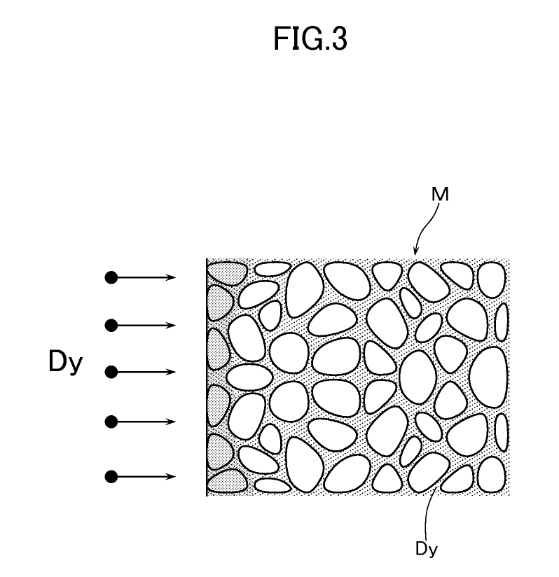

FIG. 4 is a table showing the magnetic properties of permanent magnets manufactured according to example 1.

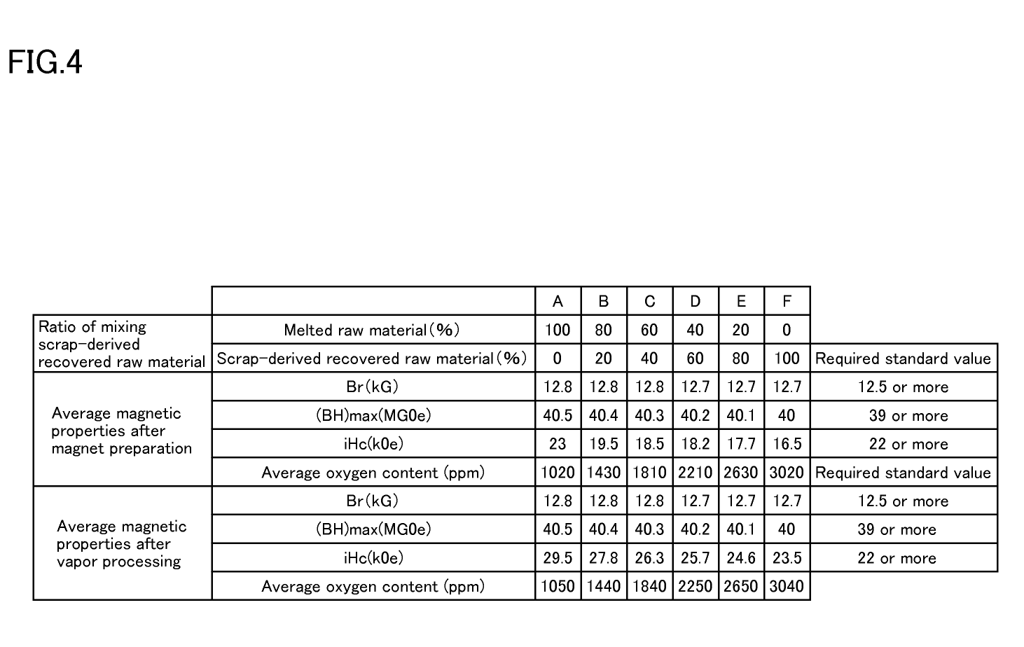

### DESCRIPTION OF REFERENCE NUMERALS AND CHARACTERS

1 vacuum vapor processing apparatus
2 evacuating means
3 vacuum chamber
4 heating means
7 processing box
71 box portion
72 lid portion
8 spacer
81 wire material
S scrap magnet
M recycled magnet
v metal evaporating material

1. A method of recycling a scrap magnet comprising the steps of:
grinding a recovered scrap magnet which is an iron-boron-rare earth-based sintered magnet, thereby obtaining a scrap-derived recovered raw material powder;
obtaining a sintered body from the scrap-derived recovered raw material powder by a powder metallurgy method; and
processing the sintered body, the processing including the steps of:
heating the sintered body disposed in a processing chamber; evaporating a metal evaporating material containing at least one of
Dy and Tb, the metal evaporating material being disposed in the same or another processing chamber;
adhering metal atoms evaporated in the evaporating step to a surface of the sintered body while controlling a supply amount of the evaporated metal atoms; and
diffusing the adhered metal atoms into a grain boundary and/or a grain boundary phase of the sintered body.

2. The method of recycling a scrap magnet according to claim 1, wherein a raw material powder obtained by grinding an alloy raw material for an iron-boron-rare earth-based sintered magnet prepared by a quenching method is added to the scrap-derived recovered raw material powder.

3. The method of recycling a scrap magnet according to claim 2, wherein the grinding is performed by each of the steps of hydrogen grinding and jet mill fine grinding.

4. The method of recycling a scrap magnet according to claim 1, further comprising the step of introducing an inert gas into the processing chamber in which the sintered body is disposed, the introduction being made while the metal evaporating material is being evaporated, so that the supply amount of the evaporated metal atoms is adjusted by varying a partial pressure of the inert gas, and that the metal atoms are diffused into the grain boundary and/or the grain boundary phase before a thin film made from the adhered metal atoms is formed.

5. The method of recycling a scrap magnet according to claim 1, further comprising the step of performing a heat treatment at a temperature below a temperature of the heating, after having diffused the metal atoms into the grain boundary and/or the grain boundary phase of the sintered body.
